(19) United States
(12) Patent Application Publication
(10) Pub. No.: US 2008/0024305 A1
(43) Pub. Date: Jan. 31, 2008

(54) PLANAR MICROSTRIP ANTENNA INTEGRATED INTO CONTAINER

(76) Inventor: Daniel D. DEAVOURS, Lawrence, KS (US)

Correspondence Address: SPENCER, FANE, BRITT & BROWNE, 1000 WALNUT STREET, SUITE 1400, KANSAS CITY, MO, 64106-2140, US

(21) Appl. No.: 11/684,406

(22) Filed: Mar. 9, 2007

Related U.S. Application Data
(60) Provisional application No. 60/820,744, filed on Jul. 28, 2006.

(51) Int. Cl. G08B 13/14

(52) U.S. Cl. 340/572.7; 340/572.8

(57) ABSTRACT

An RFID tag (20) associated with a container (22) having a container wall (24) constructed of a container material (26). The RFID tag (20) includes a microstrip antenna (32) associated with an exterior surface of the wall (24) of the container (22) and a ground plane (30) associated with an interior surface of the wall (24) of the container (22). The container material (26) is interposed between the microstrip antenna (32) and the ground plane (30) and acts as a dielectric substrate. The microstrip antenna (32) may be embedded below, substantially flush with, or affixed to the exterior surface. Similarly, the ground plane (30) may be embedded below, substantially flush with, or affixed to the interior surface. Use of the microstrip antenna (32) reduces or eliminates detuning, while locating the components below or flush with the surfaces of the container (22) protects them from damage.

### RELATED APPLICATIONS

The present non-provisional patent application is related to and claims priority benefit of an earlier-filed provisional patent application titled METHODS AND SYSTEMS FOR INTEGRATING PLANAR MICROSTRIP ANTENNA INTO CONTAINERS, Ser. No. 60/820,744, filed Jul. 28, 2006. The identified earlier-filed application is hereby incorporated by reference into the present application.

### FIELD OF THE INVENTION

The present invention relates generally to radio frequency identification (RFID) devices, and, more specifically, to RFID devices having planar microstrip antennas integrated into associated containers.

### BACKGROUND OF THE INVENTION

RFID devices are used in a variety of different applications, including, for example, monitoring, cataloging, and tracking items. An RFID system typically includes a transponder, or “tag”, for storing and transmitting data, an interrogator, or “reader”, for receiving the data from the tag, and a data communications network for conveying the data received by the interrogator to an information system.

RFID systems operate over a range of different frequencies, including low frequency (LF), typically around 125-135 KHz, high-frequency (HF), typically around 13.56 MHz, ultra-high-frequency (UHF), typically around 315 MHz, 433 MHz, or 900 MHz, and microwave radio bands, typically around 2.4 to 5.8 GHz. At LH and HF frequencies, the tag antenna is typically coupled to the interrogator antenna by a magnetic component of the reactive near-field, in which both antennas are typically configured as coils in a resonant circuit. However, typical antennas used in near-field systems are typically only a small fraction of a wavelength in their linear dimensions and, therefore, are inefficient electromagnetic radiators and receptors. As a result, the useful range of operation may be limited to as little as a few inches from the interrogator antenna. Such a short read distance is a significant disadvantage in many applications.

At UHF and microwave frequencies, the tag antenna is typically coupled to the interrogator antenna by a radiating far-field, which uses electromagnetic (EM) waves that propagates over distances typically of more than a few wavelengths. As a result, the useful range of operation can be up to twenty feet or more. However, compared to the HF band, the radiation and reception of EM waves at these higher frequency bands are affected much more strongly by obstacles and materials in the immediate environment of the antennas. In particular, attaching tags to metal objects or containers containing metal or water is problematic.

Many UHF RFID tags are provided with resonant dipole antennas. Dipole antennas are known to have good free-space characteristics, have a convenient form factor, and are easy to design and manufacture. However, dipole antennas suffer considerable performance degradation when placed near a high-loss and/or high-dielectric material, such as water, or near a conductor, such as metal. This is commonly referred to as the “metal/water problem” and occurs because the conductive or dielectric material changes the electromagnetic properties of the antenna. More specifically, when a dipole antenna is placed near a conductor, the operation of the antenna changes from that of a “free space resonator” to a “volume resonator”, which impacts the performance of the antenna in a number of ways. If the antenna is no longer resonant, it becomes less efficient at radiating and receiving RF energy. The bandwidth of the antenna becomes narrower, such that the antenna is only efficient over a much smaller range of frequencies. If the antenna is intended to operate outside of this narrow band, it will suffer degraded performance. Furthermore, the characteristic impedance of the antenna changes, typically becoming much larger. This further degrades performance by reducing efficient power transfer between the antenna and the IC. Additionally, if the antenna is very close to metal, the conductive losses of the antenna can become more pronounced, especially when not operating at its resonant frequency. If an antenna is placed near a high dielectric material, the material can change the resonant frequency of the antenna, which reduces the efficiency of the antenna and also changes the characteristic impedance of the antenna, resulting in reduced performance. Additionally, if the dielectric material is lossy (e.g., water), the dielectric loss further contributes to the degradation of antenna performance. Various solutions to these problems have been proposed, but all suffer from one or more limitations and disadvantages.

Some RFID tags are provided with microstrip antennas. A microstrip antenna is an antenna comprising a thin metallic conductor bonded to one side of a substrate, and a ground plane bonded to the opposite side of the substrate. Microstrip antennas behave primarily as volume resonators, which is fundamentally different from the dipole antennas commonly provided with UHF RFID tags. Generally, a tag incorporating a microstrip antenna also comprises a feed structure, a matching circuit, an integrated circuit, and, possibly, a battery and sensor. The antenna, feed structure, and matching circuit are designed specifically to operate with the substrate. Microstrip antennas tend to be more useful than dipole antennas because the ground plane electrically isolates the antenna from the material to which it is attached.

Generally, RFID tags are affixed to containers sometime after the containers are created, i.e., as a wholly separate and distinct step apart from the process of manufacturing or otherwise preparing the container. Many containers are so-called “RF-friendly” in that they are constructed from low loss, low dielectric materials, such as certain polymers, wood, and paper-based materials, that have minimal impact on the performance of dipole antennas. Unfortunately, as mentioned, the contents of the containers, especially aqueous or metallic contents, can aversely impact the performance and tuning of standard RFID antennas. One solution has been to construct unitary RFID tags with the aforementioned microstrip antennas, and affix the tag unit to an exterior surface of the container. The unitary tag includes at least a ground plane, a dielectric (possibly air) substrate volume, which is typically relatively thin, and an antenna plane, resulting in a relatively thick protrusion on the surface of the container which can cause packing and storage problems and which can be easily damaged. Furthermore, where the container is reusable, certain processes associated with conditioning the container for reuse, such as washing or sterilizing, can damage or remove the protruding tag unit.

### SUMMARY OF THE INVENTION

The present invention overcomes the above-described and other problems by providing an improved RFID tag associated with a container having a container wall constructed of a container material, and the RFID tag comprising a microstrip antenna associated with an exterior surface of the wall of the container and a ground plane associated with an interior surface of the wall of the container, with the container material being interposed between the microstrip antenna and the ground plane and acting as a dielectric substrate. In various embodiments, the microstrip antenna is embedded below, substantially flush with, or affixed to the exterior surface. Similarly, in various embodiments, the ground plane is embedded below, substantially flush with, or affixed to the interior surface.

The advantages provided by the present invention include allowing for reducing or eliminating protrusion of the RFID tag from either or both of the interior or exterior surfaces of the container wall, and thereby reducing or eliminating packing and storage problems and contact damage and facilitating reuse of the container, particularly where reuse is preceded by processing, e.g., washing and/or sterilizing, the used container. Furthermore, as mentioned, use of the microstrip antenna advantageously reduces or eliminates detuning, unlike standard RFID tag antennas.

These and other features of the present invention are described in more detail in the section titled DETAILED DESCRIPTION, below.

### BRIEF DESCRIPTION OF THE DRAWINGS

The following drawings form part of the present specification and are included to further demonstrate certain aspects of the present invention. The figures are examples only, and do not limit the scope of the invention.

FIG. 1 is a sectional isometric view of an embodiment of the RFID tag of the present invention integrated into a container;

FIG. 2 is a sectional elevation view of a first implementation of the RFID tag of FIG. 1 in which a microstrip antenna is affixed to an exterior surface of the container and a ground plane is affixed to an interior surface of the container;

FIG. 3 is a sectional elevation view of a second implementation of the RFID tag of FIG. 1 in which the microstrip antenna is affixed to the exterior surface and the ground plane is substantially flush with the interior surface;

FIG. 4 is a sectional elevation view of a third implementation of the RFID tag of FIG. 1 in which the microstrip antenna is affixed to the exterior surface and the ground plane is embedded below the interior surface;

FIG. 5 is a sectional elevation view of a fourth implementation of the RFID tag of FIG. 1 in which the microstrip antenna is substantially flush with the exterior surface and the ground plane is affixed to the interior surface;

FIG. 6 is a sectional elevation view of a fifth implementation of the RFID tag of FIG. 1 in which the microstrip antenna is substantially flush with the exterior surface and the ground plane is substantially flush with the interior surface;

FIG. 7 is a sectional elevation view of a sixth implementation of the RFID tag of FIG. 1 in which the microstrip antenna is substantially flush with the exterior surface and the ground plane is embedded below the interior surface;

FIG. 8 is a sectional elevation view of a seventh implementation of the RFID tag of FIG. 1 in which the microstrip antenna is embedded below the exterior surface and the ground plane is affixed to the interior surface;

FIG. 9 is a sectional elevation view of a eighth implementation of the RFID tag of FIG. 1 in which the microstrip antenna is embedded below the exterior surface and the ground plane substantially flush with the interior surface; and

FIG. 10 is a sectional elevation view of a ninth implementation of the RFID tag of FIG. 1 in which the microstrip antenna is embedded below the exterior surface and the ground plane is embedded below the interior surface.

### DETAILED DESCRIPTION

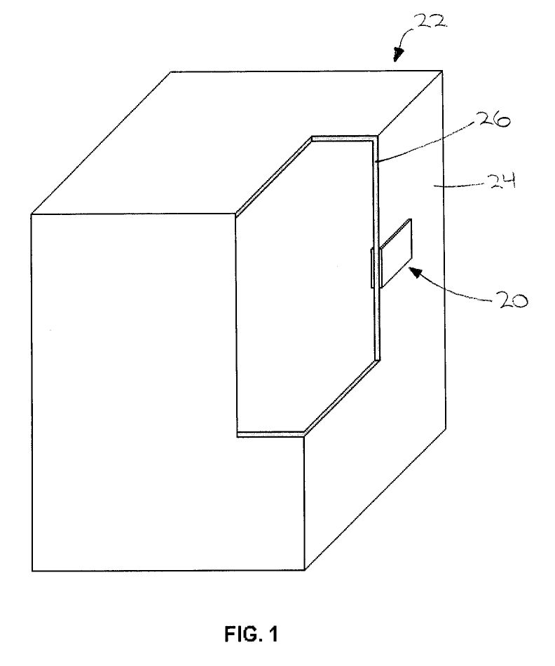

With reference to the figures, the present invention is herein described, shown, and otherwise disclosed in accordance with one or more preferred embodiments. More specifically, referring to FIG. 1, the present invention concerns an RFID tag 20 associated with a container 22 having a container wall 24 constructed from a container material 26, wherein the container material 26 provides a dielectric substrate for the RFID tag 20.

In one embodiment, the container 22 is an otherwise substantially conventional container, and the container material 26 is an otherwise substantially conventional container material having electrical properties suitable for use as a dielectric substrate for the RFID tag 20. In one embodiment, the container material 26 is high-density polyethylene (HDPE), which has a relatively low dielectric constant and a very low loss tangent. In another embodiment, the container material 26 is corrugate, a paper-based material, which, being mostly air, has a dielectric constant close to one and a loss tangent close to zero. In one embodiment, the container 22 is designed to contain and/or contains aqueous, metallic, or other contents which would act to detune or otherwise interfere with the normal operation of a standard RFID tag.

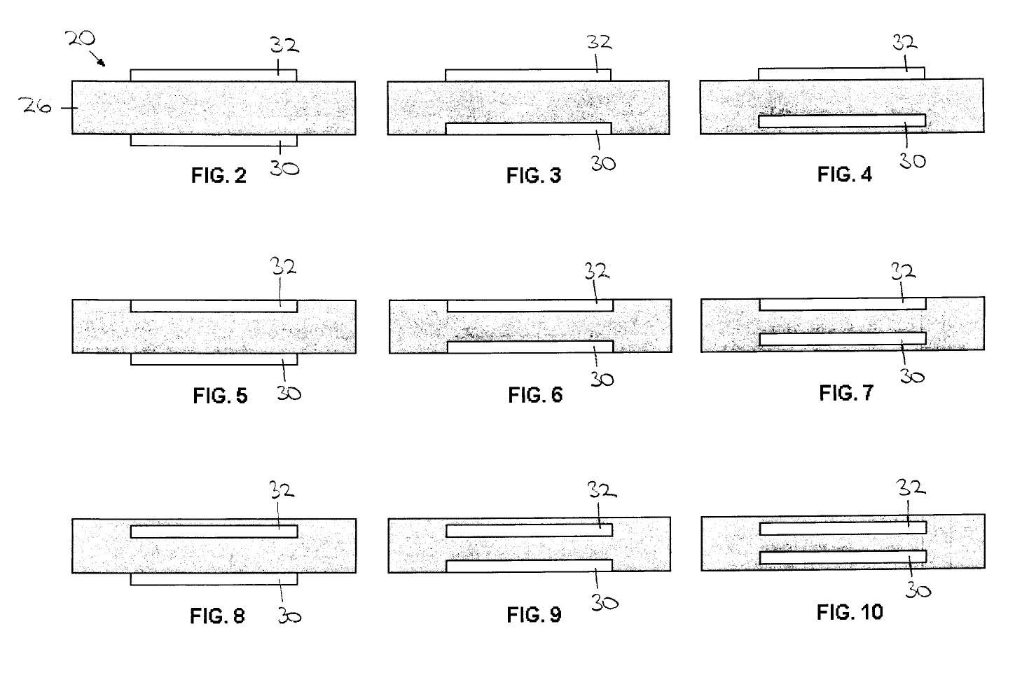

In one embodiment, referring to FIG. 2, the RFID tag 20 comprises the dielectric substrate 26, a ground plane 30, a planar microstrip antenna 32, a feed structure, a matching circuit, and an integrated circuit (IC) (shown located in the same plane as the microstrip antenna 32). In one embodiment, the IC is coupled with the matching circuit, the matching circuit is coupled with the feed structure, and the feed structure is coupled with the microstrip antenna 32. As mentioned, in one embodiment the feed structure, the matching circuit, and the IC are located on the same plane, the “antenna plane”, as the microstrip antenna 32. One or more of the feed structure, matching circuit, IC, and/or microstrip antenna 32 may be designed, selected, configured, or otherwise adapted for use with the substrate provided by the particular container material 26 and its particular electrical or other relevant properties.

Use of the microstrip antenna 32 advantageously reduces or eliminates detuning, unlike standard RFID tag antennas. As used herein, the term “planar” means “on a level that is spaced apart from and generally parallel to the ground plane”, and does not mean “flat”. Thus, in one embodiment the microstrip antenna 32 and the ground plane 30 are both planar and flat, while in another embodiment the microstrip antenna 32 and the ground plane 30 are both planar and non-flat, e.g., curved.

In one embodiment, the ground plane 30 comprises metal foil associated with, i.e., affixed to, substantially flush with, or embedded below, an interior surface of the container wall 24. In one embodiment, the microstrip antenna 32 is associated with i.e., affixed to, substantially flush with, or embedded below, an exterior surface of the container wall 24 and substantially adjacent to the ground plane 30, with at least some thickness of the container material 26 being interposed between the ground plane 30 and the microstrip antenna 32. In embodiments in which the microstrip antenna 32 is embedded below the exterior surface of the container 22, the thickness of the container material 26 interposed between the embedded microstrip antenna 32 and the exterior surface functions as a superstrate, and the microstrip antenna 32 may need to be tuned to account for the material and thickness of the superstrate.

More specifically, in FIG. 2 the microstrip antenna 32 is affixed to the exterior surface of the container 22 and the ground plane 30 is affixed to the interior surface of the container 22. In FIG. 3 the microstrip antenna 32 is affixed to the exterior surface and the ground plane 30 is substantially flush with the interior surface. In FIG. 4 the microstrip antenna 32 is affixed to the exterior surface and the ground plane 30 is embedded below the interior surface. In FIG. 5 the microstrip antenna 32 is substantially flush with the exterior surface and the ground plane 30 is affixed to the interior surface. In FIG. 6 the microstrip antenna 32 is substantially flush with the exterior surface and the ground plane 30 is substantially flush with the interior surface. In FIG. 7 the microstrip antenna 32 is substantially flush with the exterior surface and the ground plane 30 is embedded below the interior surface. In FIG. 8 the microstrip antenna 32 is embedded below the exterior surface and the ground plane 30 is affixed to the interior surface. In FIG. 9 the microstrip antenna 32 is embedded below the exterior surface and the ground plane 30 substantially flush with the interior surface. In FIG. 10 the microstrip antenna 32 is embedded below the exterior surface and the ground plane 30 is embedded below the interior surface.

From the foregoing discussion, one with ordinary skill in the art would appreciate the advantages provided by the present invention, including allowing for reducing or eliminating protrusion of the RFID tag from either or both of the interior or exterior surfaces of the container wall, and thereby reducing or eliminating packing and storage problems and contact damage and facilitating reuse of the container, particularly where reuse is preceded by processing, e.g., washing and/or sterilizing, the used container. Furthermore, as mentioned, use of the microstrip antenna advantageously reduces or eliminates detuning, unlike standard RFID tag antennas.

All of the apparatuses and methods disclosed and claimed herein can be made and executed without undue experimentation in light of the present disclosure. While the present invention has been described in terms of particular embodiments, it will be apparent to those of ordinary skill in the art that variations may be applied to the methods and in the steps or in the sequence of steps of the method described herein without departing from the concept, spirit, and scope of the invention. All such similar substitutes and modifications apparent to those skilled in the art are deemed to be within the spirit, scope, and concept of the disclosure as defined by the appended claims.

1. A radio frequency identification transponder associated with a container constructed of a container material, the radio frequency identification transponder comprising:
a planar microstrip antenna associated with an exterior surface of the container; and
a ground plane associated with an interior surface of the container,
wherein at least a portion of the container material is interposed between the planar microstrip antenna and the ground plane and acts as a dielectric substrate.

2. The radio frequency identification transponder as set forth in claim 1, wherein the planar microstrip antenna is not flat.

3. The radio frequency identification transponder as set forth in claim 1, wherein the planar microstrip antenna is embedded below the exterior surface.

4. The radio frequency identification transponder as set forth in claim 1, wherein the planar microstrip antenna is substantially flush with the exterior surface.

5. The radio frequency identification transponder as set forth in claim 1, wherein the planar microstrip antenna is affixed to the exterior surface.

6. The radio frequency identification transponder as set forth in claim 1, wherein the ground plane is embedded below the interior surface.

7. The radio frequency identification transponder as set forth in claim 1, wherein the ground plane is substantially flush with the interior surface.

8. The radio frequency identification transponder as set forth in claim 1, wherein the ground plane is affixed to the interior surface.

9. A radio frequency identification transponder associated with a container constructed of a container material, the radio frequency identification transponder comprising:
a microstrip antenna associated with an exterior surface of the container and located on an antenna plane;
a feed structure coupled with the microstrip antenna, a matching circuit coupled with the feed structure, and an integrated circuit coupled with the matching circuit, all located on the antenna plane; and
a ground plane associated with an interior surface of the container,
wherein at least a portion of the container material is interposed between the antenna plane and the ground plane and acts as a dielectric substrate.

10. The radio frequency identification transponder as set forth in claim 8, wherein the microstrip antenna is not flat.

11. The radio frequency identification transponder as set forth in claim 8, wherein the microstrip antenna is embedded below the exterior surface.

12. The radio frequency identification transponder as set forth in claim 8, wherein the microstrip antenna is substantially flush with the exterior surface.

13. The radio frequency identification transponder as set forth in claim 8, wherein the microstrip antenna is affixed to the exterior surface.

14. The radio frequency identification transponder as set forth in claim 8, wherein the ground plane is embedded below the interior surface.

15. The radio frequency identification transponder as set forth in claim 8, wherein the ground plane is substantially flush with the interior surface.

16. The radio frequency identification transponder as set forth in claim 8, wherein the ground plane is affixed to the interior surface.

17. A container comprising:
a container wall constructed of a container material; and
a radio frequency identification transponder including—
a microstrip antenna associated with an exterior surface of the container wall, and
a ground plane associated with an interior surface of the container wall,
wherein at least a portion of the container material is interposed between the microstrip antenna and the ground plane and acts as a dielectric substrate.

18. The container as set forth in claim 16, wherein the microstrip antenna is not flat.

19. The container as set forth in claim 16, wherein the microstrip antenna is embedded below the exterior surface.

20. The container as set forth in claim 16, wherein the microstrip antenna is substantially flush with the exterior surface.

21. The container as set forth in claim 16, wherein the microstrip antenna is affixed to the exterior surface.

22. The container as set forth in claim 16, wherein the ground plane is embedded below the interior surface.

23. The container as set forth in claim 16, wherein the ground plane is substantially flush with the interior surface.

24. The container as set forth in claim 16, wherein the ground plane is affixed to the interior surface.

25. A radio frequency identification transponder for association with a container constructed of a particular container material, the radio frequency identification transponder comprising:
a planar microstrip antenna for association with an exterior surface of the container, wherein the planar microstrip antenna is designed to operate with at least a portion of the particular container material being used as a dielectric substrate; and
a ground plane for association with an interior surface of the container.

26. A method of constructing a container having a container wall constructed from a container material, the method comprising the steps of:
associating a planar microstrip antenna with an exterior surface of the container wall, and
associating a ground plane with an interior surface of the container wall such that at least a portion of the container material is interposed between the planar microstrip antenna and the ground plane and acts as a dielectric substrate.
